(19) United States
(12) Patent Application Publication
(10) Pub. No.: US 2026/0043723 A1
(43) Pub. Date: Feb. 12, 2026

(54) Adjustable Tilt Angle Compression Device for Mechanical Abuse Testing of Lithium-Ion Batteries and Test Method Thereof

(71) Applicant: Nanjing Tech University, Nanjing City (CN)

(72) Inventors: Zhirong Wang, Nanjing City (CN); Jinlong Bai, Nanjing City (CN); Yun Yang, Nanjing City (CN)

(21) Appl. No.: 19/264,814

(22) Filed: Jul. 9, 2025

(30) Foreign Application Priority Data
Aug. 8, 2024 (CN) 202411082308.5

(51) Int. Cl. G01N 3/04; G01N 3/08; H01M 10/42

(52) U.S. Cl. CPC G01N 3/04; G01N 3/08; H01M 10/4285; G01N 2203/0003; G01N 2203/0019; G01N 2203/0226; G01N 2203/0228; G01N 2203/0258

(57) ABSTRACT

The present invention relates to the field of batteries, and particularly to a device and method for mechanical abuse testing of batteries. Existing devices apply compression vertically to the battery's force-bearing surface, which does not adequately simulate complex mechanical abuse during tilted scenarios. Specifically, they cannot compress the battery at multiple angles or collect compressive force values from different orientations. The invention provides an adjustable-tilt compression device for mechanical abuse testing of lithium-ion batteries. By tilting the battery support plate of the fixture, the device enables multi-angle compression and collection of force data from various angles, allowing for comprehensive testing of mechanical stresses encountered in real-world tilted abuse conditions. Additionally, the device supports testing at multiple points and under varying temperatures, enhancing the reliability and coverage of mechanical abuse assessments for battery safety evaluation.

### TECHNICAL FIELD

The present invention is in the technical field of batteries, and more particularly relates to an adjustable tilt angle compression device for mechanical abuse testing of lithium-ion batteries and a test method thereof.

### BACKGROUND ART

During operation, electric vehicles may encounter various road conditions, where battery packs installed in the chassis may collide with or scrape against objects. Additionally, in traffic accidents, battery packs may suffer impacts and compression from other vehicles or obstacles. The angles and magnitudes of these impacts vary, resulting in diverse forms of mechanical abuse experienced by battery packs in real-world scenarios.

The internal structure of a lithium-ion battery consists of a separator sandwiched between cathode and anode electrode plates as an insulating layer. These three layers are then wound or stacked to form a multi-layer or wound cell structure. Consequently, the battery's intricate multi-layer internal structure is prone to rupture and fracture under mechanical abuse. Contact between the cathode and anode at damaged areas triggers internal short circuits, leading to battery failure and temperature rise. The heat generated by internal short circuits may elevate the battery's temperature beyond the thermal runaway threshold, causing thermal runaway, fires, or explosions. Thus, mechanical abuse testing is critical to determine the battery's tolerance limits and assess how different types of mechanical abuse influence thermal runaway initiation.

Current mechanical abuse testing for batteries typically employs universal mechanical testing machines or horizontal mechanical stamping devices to apply lateral or vertical compression. For example, Chinese Patent No. CN202320859530.6, titled “Detection Testing Machine for Battery Compression Test” discloses a device for mechanical compression test. However, such devices apply force only vertical to the battery's compression surface, limiting testing to pure compression or impact and failing to simulate inclined collision states during electric vehicle movement. Due to movement and compression angles, real-world impacts often combine compression and sliding shear rather than acting purely perpendicularly. The deformation behavior of the battery's multi-layer structure under vertical compression differs from that under inclined compression, as inclined compression induces sliding delamination of the layers. This results in distinct internal short-circuit patterns and thermal runaway characteristics, making inclined compression or impact testing essential for comprehensively evaluating battery safety in practice.

Existing equipment applies mechanical compression and impact forces perpendicular to the battery's surface during abuse testing, resulting in one-dimensional force testing that cannot fully replicate the complex stresses experienced during real-world inclined mechanical abuse. Specifically, these systems cannot perform multi-angle compression or collect compressive force values at multiple angles.

### SUMMARY OF THE INVENTION

The present invention proposes an adjustable tilt angle compression device for mechanical abuse testing of lithium-ion batteries and a test method thereof to achieve multi-angle compression of the battery and collect compressive force values at multiple angles.

In order to achieve the above-mentioned objective, the present invention is implemented by the following scheme:
an adjustable tilt angle compression device for mechanical abuse testing of lithium-ion batteries, which includes
a top plate,
a sensor for collecting compressive force values in the vertical direction, the horizontal direction and the direction vertical to a tilted plane;
a compression mechanism that presses the battery;
a battery support plate for securing the battery;
a planar movement mechanism for moving the battery support plate transversely and/or longitudinally in a plane;
a tilt adjustment mechanism for adjusting tilt of the battery to achieve compression of different tilts of the battery.

Preferably, the sensor includes:
a support plate force value sensor for collecting force values vertical to the support plate direction exerted on the battery;
a compression axis horizontal force value sensor for collecting horizontal force values in different directions exerted on the compression axis during battery compression;
a compression axis vertical force value sensor for collecting vertical force values exerted on the compression axis.

Preferably, the compression mechanism includes:
a compression axis fixing plate located below the top plate and is provided with one fixing plate threaded hole, a smooth bore A, a smooth bore B and a smooth bore C;
a compression axis having a top fixedly connected to the compression axis fixing plate via the compression axis vertical force value sensor;
a compression axis limiting plate located below the compression axis fixing plate and provided with a threaded hole, a first smooth bore, a second smooth bore and a third smooth bore, where a hole is provided in the center, a compression axis limiting linear bearing is provided in the hole, a hole wall of the hole is uniformly distributed and fixedly connected to the plurality of compression axis horizontal force value sensors in the circumferential direction, an outer peripheral wall of the compression axis limiting linear bearing movably abuts against a side wall of the compression axis horizontal force value sensor, and the compression axis limiting linear bearing is sleeved on the compression axis;
a compression axis fixing plate stud rotatably connected to the top plate and threadedly connected to a fixing plate threaded hole of the compression axis fixing plate and extending into the first smooth bore of the compression axis limiting plate;
a compression axis limiting plate stud rotatably connected to the top plate, extends through the smooth bore A of the compression axis fixing plate, and is threadedly connected to the threaded hole of the compression axis limiting plate;
two positioning smooth shafts fixedly connected to a base and the top plate, where one of the positioning smooth shafts extends through the second smooth bore of the compression axis limiting plate and the smooth bore B of the compression axis fixing plate, and the other extends through the third smooth bore of the compression axis limiting plate and the smooth bore C of the compression axis fixing plate;
a compression axis limiting plate stud servo motor mounted below the base for driving rotation of the compression axis limiting plate stud, and a rotation speed of the compression axis limiting plate stud servo motor being adjustable; and
a compression axis fixing plate stud servo motor mounted below the base for driving the compression axis fixing plate stud to rotate, and the rotation speed of the compression axis fixing plate stud servo motor being adjustable.

Preferably, the battery support plate includes a first battery support plate and a second battery support plate which are parallel to each other, and the support plate force value sensor being arranged between the first battery support plate and the second battery support plate.

The planar movement mechanism includes
a base provided with a bottom bracket positioning block longitudinal movement guide rail and a bottom bracket positioning block transverse movement guide rail;
a bottom bracket positioning block transverse movement servo motor;
a bottom bracket positioning block longitudinal movement servo motor;
a bottom bracket positioning block provided with longitudinal movement threaded holes and transverse movement threaded holes;
a limiting slide block including a first limiting slide block and a second limiting slide block with the same structure, where the first limiting slide block is slidably connected to a bottom bracket positioning block transverse movement guide rail, and the second limiting slide block is slidably connected to a bottom bracket positioning block longitudinal movement guide rail;
bottom bracket positioning block transverse movement studs threadedly connected to the transverse movement threaded holes, respectively having one end rotatably connected to the first limiting slide block via a stud limiting bearing and the other end fixedly connected to the rotation axis of the bottom bracket positioning block transverse movement servo motor;
bottom bracket positioning block longitudinal movement studs threadedly connected to the longitudinal movement threaded holes, respectively having one end rotatably connected to the second limiting slide block via a stud limiting bearing and the other end fixedly connected to the rotation axis of the bottom bracket positioning block longitudinal movement servo motor;

the tilt adjustment mechanism includes:
a bottom bracket fixedly connected to the bottom bracket positioning block;
a driving gear fixedly connected to a central axis of the driving gear, where the central axis of the driving gear is fixedly connected to a driving gear bearing, and is rotatably connected to the bottom bracket via the driving gear bearing;
a driven gear fixedly connected to a central axis of the driven gear, where the central axis of the driven gear is rotatably connected to the bottom bracket via the driven gear bearing, and the driven gear and the driving gear are meshed and connected to each other; an outer side face of the driven gear is cut away by a plane parallel to the central axis of the driven gear to form a mounting plane, and the driven gear is fixedly connected to the battery support plate via the mounting plane; and
a bottom bracket driving gear servo motor having a rotation axis fixedly connected to the central axis of the driving gear for driving the driving gear to rotate.

Preferably, the limiting slide block is provided with a positioning pulley central axis rotatably connected with a positioning pulley, and the bottom bracket positioning block longitudinal movement guide rail and the bottom bracket positioning block transverse movement guide rail are provided with a sliding groove matched with the positioning pulley on the outer side.

Preferably, the number of bottom bracket positioning block transverse movement studs and the transverse movement threaded holes matches the number of the bottom bracket positioning block longitudinal movement studs and the longitudinal movement threaded holes.

Preferably, further included is a liquid temperature regulating system to cyclically deliver liquids at different temperatures to the battery support plate;
the liquid temperature regulating system includes:
an internal duct provided inside a first battery support plate of an upper plate of the battery support plate;
a liquid circulation duct having one end communicated with the internal duct via a duct connector and the other end communicated with the temperature regulating device; and
a temperature regulating device including a water pump, a heater and a cooling machine, where after external liquid is heated by the heater or cooled by the cooling machine, the external liquid is circulated by the water pump to a liquid circulation duct.

The present invention provides a battery test method using an adjustable tilt angle compression device for mechanical abuse testing of lithium-ion batteries:

the method includes the steps of:
step one S1: securing the battery to the first battery support plate;
step two S2: adjusting a tilt angle of the battery support plate:
adjusting the tilt angle of the battery support plate to a target angle by a bottom bracket driving gear servo motor;
step three S3: adjusting position of the bottom bracket positioning block on the plane:
adjusting the position of the bottom bracket positioning block on the plane via a bottom bracket positioning block transverse movement servo motor and a bottom bracket positioning block longitudinal movement servo motor to adjust a pressed position of the battery;
step four S4: adjusting a vertical position of the compression axis fixing plate and the compression axis limiting plate:
adjusting the vertical position of the compression axis limiting plate by driving rotation of a compression axis limiting plate stud via a compression axis limiting plate stud servo motor; and by means of the compression axis fixing plate stud servo motor, driving the rotation of the compression axis fixing plate stud to adjust the vertical position of the compression axis fixing plate, such that a compression head is about to contact a battery surface while the compression axis limiting plate does not obstruct observation of a thermal runaway flame of the battery;
step five S5: compression test:
controlling the compression axis fixing plate stud servo motor to drive the compression axis fixing plate to press down, so that the compression head performs a compression test on the battery;
step six S6: compressive force value collection:
during the step five S5 test, collecting vertical force values exerted on the compression axis via the compression axis vertical force value sensor; collecting horizontal force values exerted on the compression axis via the compression axis horizontal force value sensor; and collecting the force values vertical to the battery support plate exerted on the battery via the support plate force value sensor;
step seven S7:
S7-1: reselecting a compressed position of the battery:
after the above-mentioned compression test is completed, lifting the compression head, and in the case where the battery is not damaged, repeating S3, reselecting the pressed position of the battery, and repeating S4-6 to achieve a multi-point test on the battery;
and/or, S7-2, readjusting the tilt angle of the battery support plate:

after the above compression test is completed, lifting the compression head, and in the case where the battery is not damaged, repeating S2, adjusting the tilt angle of the battery support plate to a different target angle, and repeating S4-6 to achieve a multi-tilt angle test on the battery.

Preferably, during the whole process of executing steps S1-7,

the liquid temperature regulating system is started to cyclically deliver liquids at different temperatures to the battery support plate to achieve the compression test at different temperatures:
when the compression test at a high temperature is required, the heater is operated to heat the liquid, and a water pump circulates the high-temperature liquid to a liquid circulation duct;
when it is required to perform the compression test at low temperature, a cooling machine is operated to cool the liquid, and the low temperature liquid is circulated to the liquid circulation duct by the water pump.

Preferably, the step S2 is performed before the step S3; or, the step S2 and the step S3 are performed simultaneously; or, the step S2 is performed after the step S3.

Preferably, in the step S5, the following measures are taken to adjust the rotation speed of the compression axis fixing plate stud servo motor to perform compression test on the battery:
adjusting the compression speed by adjusting the rotation speed of the compression axis fixing plate stud servo motor to achieve compression at a fixed speed;
or, adjusting the rotation speed of the compression axis fixing plate stud servo motor by changing the force value of the compression axis vertical force value sensor to achieve vertical uniform compressive force application;
or, adjusting the rotation speed of the compression axis fixing plate stud servo motor by changing the force value of the support plate force value sensor to achieve the uniform compressive force application vertical to the battery surface.

The advantageous effects of the present invention over the prior art are:
1. The adjustable tilt of the battery support plate according to the present invention enables the battery to be compressed at multiple angles, and the compressive force values at multiple angles are collected, so that the complex forces of the battery during the misuse of the tilting machine in practice can be fully tested.
2. The battery support plate according to the present invention can move a position on a plane and adjust a pressed position of the battery, so that the battery can be pressed at multiple points, and thus a multi-point test for the battery can be achieved.
3. The rotation speed of the compression axis fixing plate stud servo motor according to the present invention can be adjusted, so that the compression at a fixed speed, the vertical uniform compressive force application and the uniform compressive force application can be achieved.
4. Due to the combined use of the liquid temperature regulating system in the present invention, compression test at different temperatures can be achieved.

### BRIEF DESCRIPTION OF THE DRAWINGS

FIG. 1 is a front view of a body structure of a test device;

FIG. 2 is a side view of a body structure of a test device;

FIG. 3 is a schematic diagram showing a bottom bracket and a tilt adjustment mechanism;

FIG. 4 is a top plan view of a limiting plate;

FIG. 5 is a schematic diagram showing a planar movement mechanism;

FIG. 6 is a schematic diagram showing a limiting slide block;

FIG. 7 is a schematic diagram showing a base and a bottom bracket positioning block longitudinal movement guide rail;

FIG. 8 is a schematic diagram showing a base and a bottom bracket positioning block transverse movement guide rail;

FIG. 9 is a schematic diagram showing a battery support plate and a liquid temperature regulating system;

FIG. 10 is a schematic diagram showing a positional relationship of transverse movement-related parts in a planar movement mechanism;

FIG. 11 is a schematic diagram showing a battery fixing device;

FIG. 12 is a driven gear axonometric view; and

FIG. 13 is a block diagram showing an automatic control system.

100. Battery; 101. Support plate force value sensor; 102. Battery support plate; 102-1. First battery support plate; 102-2. Second battery support plate; 103. Driving gear bearing; 104-1. Longitudinal movement threaded hole; 104-2. Transverse movement threaded hole; 105. Driven gear; 1051. Mounting plane; 106. Driven gear bearing; 107. Bottom bracket; 108. Driving gear; 109. Bottom bracket positioning block; 110. Clamping plate; 111. Side plate; 112. Tightening handle; 113. Screw; 201. Base; 202. Bottom bracket positioning block longitudinal movement guide rail; 203. Bottom bracket positioning block transverse movement guide rail; 204. Bottom bracket positioning block transverse movement stud; 205. Bottom bracket positioning block longitudinal movement stud; 206. Bottom bracket positioning block transverse movement servo motor; 207. Bottom bracket positioning block Longitudinal movement servo motor; 300. Liquid temperature regulating system; 301. Duct connector; 302. Inner duct; 303. Liquid circulation duct; 304. Temperature regulating device; 305. Support plate temperature sensor; 401. Compression axis limiting plate; 402. Compression axis limiting plate threaded hole; 403. First smooth bore; 404. Compression axis limiting linear bearing; 405. Compression axis horizontal force value sensor; 406. Second smooth bore; 407. Third smooth bore; 500. Limiting slide block; 500-1. First limiting slide block; 500-2. Second limiting slide block; 501. Positioning pulley; 502. Positioning pulley central axis; 503. Stud limiting bearing; 601. Compression axis vertical force value sensor; 602. Compression axis; 603. Compression axis fixing plate stud; 604. Bottom bracket driving gear servo motor; 605. Compression axis limiting plate stud; 606. Top plate; 607. Compression axis fixing plate; 608. Positioning smooth shaft; 609. Compression head; 610. Compression axis limiting plate stud servo motor; 611. Compression axis fixing plate stud servo motor; 613. Human-machine interface; 614. Data display and storage module; 615. Control computer.

### DETAILED DESCRIPTION OF THE INVENTION

To ensure clarity regarding the objectives, technical solutions, and advantages of the embodiments of the present invention, the technical solutions of the invention will be clearly and comprehensively described below in conjunction with the accompanying drawings. Evidently, the described embodiments represent only a subset of the embodiments of the present invention and not all possible embodiments. Based on the embodiments of the present invention, all other embodiments obtainable by a person of ordinary skill in the art without exercising inventive effort shall fall within the scope of protection of the present invention.

### Embodiment 1

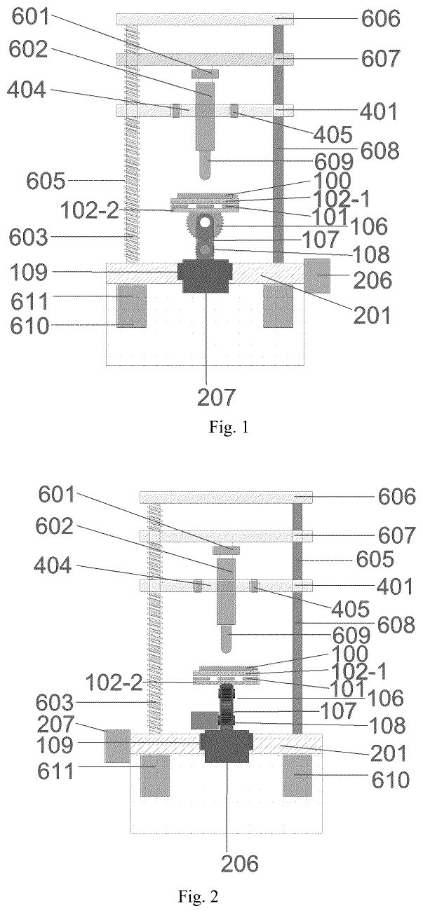

As shown in FIGS. 1 and 2, an adjustable tilt angle compression device for mechanical abuse testing of lithium-ion batteries includes a top plate 606, a sensor, a compression mechanism, a battery support plate 102, a planar movement mechanism, and a tilt adjustment mechanism.

The sensor includes the sensor comprises: a support plate force value sensor 101 for collecting force values vertical to the support plate direction exerted on the battery; a compression axis horizontal force value sensor 405 for collecting horizontal force values in different directions exerted on the compression axis during battery compression; a compression axis vertical force value sensor 601 for collecting vertical force values exerted on the compression axis.

The compression mechanism includes a compression axis fixing plate 607 located below a top plate 606 and is provided with a fixing plate threaded hole, a smooth bore A, a smooth bore B and a smooth bore C (the fixing plate threaded hole, the smooth bore A, the smooth bore B and the smooth bore C on the compression axis fixing plate 607 are not shown), and a compression axis (602) having a top fixedly connected to the compression axis fixing plate 607 via the compression axis vertical force value sensor 601; a compression axis limiting plate 401 located below the compression axis fixing plate 607 and provided with a threaded hole 402, a first smooth bore 403, a second smooth bore 406 and a third smooth bore 407, wherein a hole is provided in the center, a compression axis limiting linear bearing 404 is provided in the hole, a hole wall of the hole is uniformly distributed and fixedly connected to the plurality of compression axis horizontal force value sensors 405 in the circumferential direction. Four compression axis horizontal force value sensors 405 are selected in the present embodiment, the outer peripheral wall of the compression axis limiting linear bearing 404 is in movable contact with the side wall of the compression axis horizontal force value sensor 405, and the compression axis limiting linear bearing 404 is sleeved on the compression axis 602.

A compression axis fixing plate stud 603 rotatably connected to the top plate 606 and threadedly connected to a fixing plate threaded hole of the compression axis fixing plate 607 and extending into the first smooth bore 403 of the compression axis limiting plate 401.

A compression axis limiting plate stud 605 rotatably connected to the top plate 606, extends through the smooth bore A of the compression axis fixing plate 607, and is threadedly connected to the threaded hole 402 of the compression axis limiting plate 401; the inner diameter of the smooth bore A is greater than the outer diameter of the compression axis limiting plate stud 605, and the compression axis limiting plate stud 605 extends therethrough, so that the compression axis limiting plate stud 605 can rotate freely to drive the vertical movement of the compression axis limiting plate 401 without affecting the compression axis fixing plate 607.

Two positioning smooth shafts 608 fixedly connected to a base 201 and the top plate 606, where one of the positioning smooth shafts extends through the second smooth bore 406 of the compression axis limiting plate 401 and the smooth bore B of the compression axis fixing plate 607, and the other extends through the third smooth bore 407 of the compression axis limiting plate 401 and the smooth bore C of the compression axis fixing plate 607.

A compression axis limiting plate stud servo motor 610 mounted below the base 201 for driving rotation of the compression axis limiting plate stud 605, and a rotation speed of the compression axis limiting plate stud servo motor 610 being adjustable; and

a compression axis fixing plate stud servo motor 611 mounted below the base 201 for driving the compression axis fixing plate stud 603 to rotate, and the rotation speed of the compression axis fixing plate stud servo motor 611 being adjustable.

The compression axis limiting plate 401, see FIG. 4, the compression axis limiting plate threaded hole 402 is provided on the compression axis limiting plate 401, the compression axis limiting plate stud 605 meshes with the threaded hole, and the compression axis limiting plate stud servo motor 610 drives the compression axis limiting plate 401 to move up and down by rotating the compression axis limiting plate stud 605; in addition, the first smooth bore 403, the second smooth bore 406 and the third smooth bore 407 are provided on the compression axis limiting plate 401, and two positioning smooth shafts 608 fixed on the base 201 respectively extend through the second smooth bore 406 and the third smooth bore 407 for keeping the compression axis limiting plate 401 horizontal during the vertical movement. The first smooth bore 403 is used for extending through the compression axis fixing plate stud 603, and the diameter of the first smooth bore 403 is greater than the compression axis fixing plate stud 603; therefore, during the vertical movement of the compression axis fixing plate 607 driven by the rotation of the compression axis fixing plate stud 603, the compression axis limiting plate 401 is not affected, and the independent movement of the compression axis limiting plate 401 and the compression axis fixing plate 607 can be achieved; similarly, the compression axis fixing plate 607 is provided with a fixing plate threaded hole at a position corresponding to the first smooth bore 403, the compression axis fixing plate stud 603 is fitted and connected to the fixing plate threaded hole, and the compression axis fixing plate stud servo motor 611 drives the compression axis fixing plate 607 to move up and down by rotating the compression axis fixing plate stud 603.

FIG. 1 is a front view of a structure of a device, where the compression axis limiting plate stud 605 is covered by the compression axis fixing plate stud 603, and the compression axis limiting plate stud servo motor 610 is covered by the compression axis fixing plate stud servo motor 611, so that a marking line of the compression axis limiting plate stud 605 and the compression axis limiting plate stud servo motor 610 is a dotted line; and FIG. 2 is a side view of a structure of a device, where the compression axis limiting plate stud 605 is covered by the positioning smooth shaft 608, so that the marking line of the compression axis limiting plate stud 605 is a dotted line.

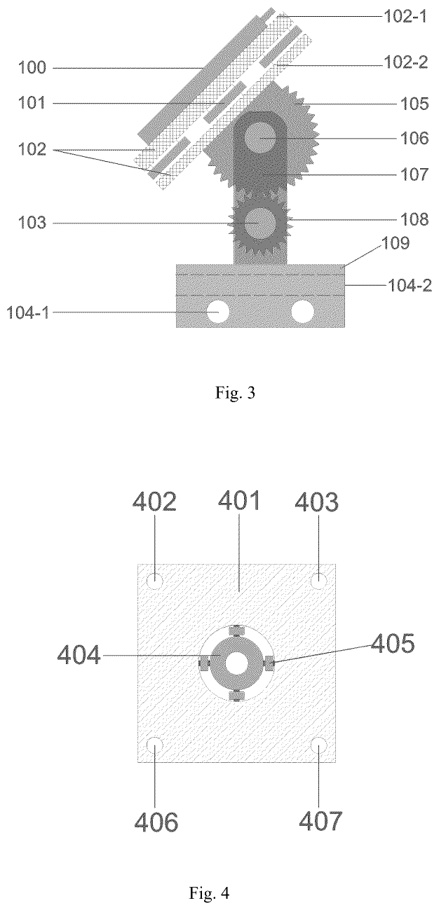

Referring to FIG. 3, the battery support plate 102 includes a first battery support plate 102-1 and a second battery support plate 102-2 which are parallel to each other, and the support plate force value sensor 101 being arranged between the first battery support plate 102-1 and the second battery support plate 102-2.

With reference to FIGS. 3, 5-7 and 10, a planar movement mechanism includes a base 201, where a bottom bracket positioning block longitudinal movement guide rail 202 and a bottom bracket positioning block transverse movement guide rail 203 are provided on the base 201;
a bottom bracket positioning block transverse movement servo motor 206;
a bottom bracket positioning block longitudinal movement servo motor 207;
A bottom bracket positioning block 109 is provided with longitudinal movement threaded holes 104-1 and transverse movement threaded holes 104-2, and the two broken lines in FIG. 3 indicate the non-visible transverse movement threaded holes 104-2.

A limiting slide block 500 including a first limiting slide block 500-1 and a second limiting slide block 500-2 with the same structure, where the first limiting slide block 500-1 is slidably connected to a bottom bracket positioning block transverse movement guide rail 203, and the second limiting slide block 500-2 is slidably connected to a bottom bracket positioning block longitudinal movement guide rail 202.

The limiting slide block 500 is provided with a positioning pulley central axis 502 rotatably connected with a positioning pulley 501, and the bottom bracket positioning block longitudinal movement guide rail 202 and the bottom bracket positioning block transverse movement guide rail 203 are provided with a sliding groove matched with the positioning pulley 501 on the outer side.

As shown in FIG. 6, the positioning pulley 501 is provided on the limiting slide block 500, and the positioning pulley 501 is connected to the limiting slide block 500 via a positioning pulley central axis 502, so that the positioning pulley 501 can rotate. The upper and lower end surfaces of the upper and lower outer sides of the movement guide rail on the base are provided with sliding grooves matching the positioning pulleys 501, so that the pulleys can rotate in the grooves to make the movement of the bottom bracket positioning block 109 smoother.

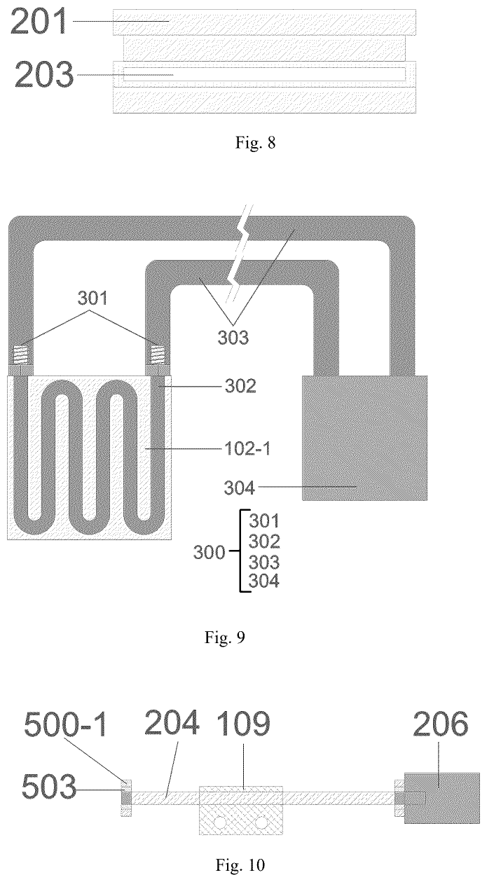

As shown in FIG. 10, in the case of transverse movement, a pair of bottom bracket positioning block transverse movement studs 204 are connected to a first limiting slide block 500-1, which is used to ensure the straightness of the bottom bracket positioning block 109 during movement. The bottom bracket positioning block transverse movement stud 204 is connected with the first limiting slide block 500-1 via the stud limiting bearing 503, so that the threaded axis can rotate freely. As shown in FIGS. 7 and 8, the base 201 is provided with a bottom bracket positioning block longitudinal movement guide rail 202 and a bottom bracket positioning block transverse movement guide rail 203 for fixing the linear movement of the limiting slide block.

Bottom bracket positioning block transverse movement studs 204 threadedly connected to the transverse movement threaded holes 104-2, respectively having one end rotatably connected to the first limiting slide block 500-1 via a stud limiting bearing 503 and the other end fixedly connected to the rotation axis of the bottom bracket positioning block transverse movement servo motor 206;

bottom bracket positioning block longitudinal movement studs 205 threadedly connected to the longitudinal movement threaded holes 104-1, respectively having one end rotatably connected to the second limiting slide block 500-2 via a stud limiting bearing 503 and the other end fixedly connected to the rotation axis of the bottom bracket positioning block longitudinal movement servo motor 207.

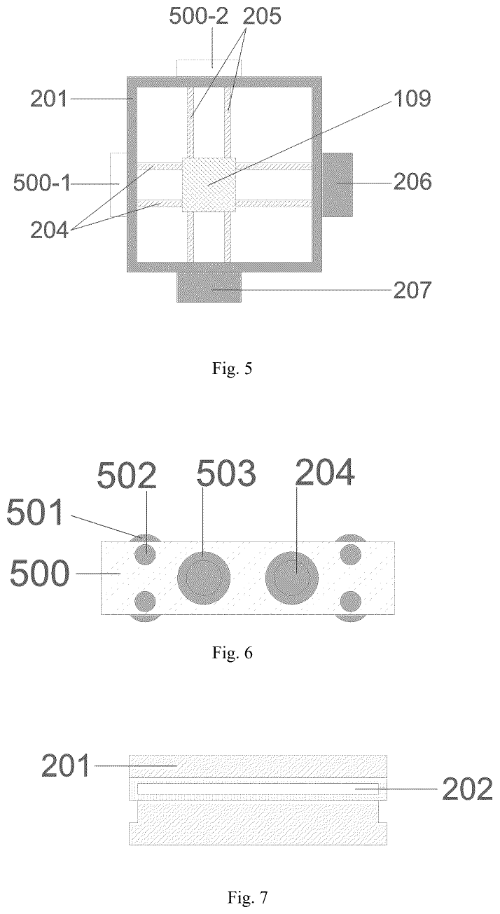

As shown in FIG. 5, the number of bottom bracket positioning block transverse movement studs 204 and the transverse movement threaded holes 104-2 matches the number of the bottom bracket positioning block longitudinal movement studs 205 and the longitudinal movement threaded holes 104-1.

In the present embodiment, in order to increase stability during movement of the bottom bracket positioning block 109, the bottom bracket positioning block transverse movement studs 204, the transverse movement threaded holes 104-2, the bottom bracket positioning block longitudinal movement studs 205, and the longitudinal movement threaded holes 104-1 are all configured in dual pairs, with two units employed for each component.

Referring to FIGS. 2, 3 and 13, the tilt adjustment mechanism includes:
a bottom bracket 107 fixedly connected to a bottom bracket positioning block 109; and a driving gear 108 fixedly connected to a central axis of the driving gear 108, where the central axis of the driving gear 108 is fixedly connected to a driving gear bearing 103, and is rotatably connected to the bottom bracket 107 via the driving gear bearing 103.

A driven gear 105 fixedly connected to a central axis of the driven gear, wherein the central axis of the driven gear is rotatably connected to the bottom bracket 107 via the driven gear bearing 106, and the driven gear 105 and the driving gear 108 are meshed and connected to each other; an outer side face of the driven gear 105 is cut away by a plane parallel to the central axis of the driven gear to form a mounting plane 1051, and the driven gear 105 is fixedly connected to the battery support plate 102 via the mounting plane 1051. FIG. 12 is an axonometric view of a driven gear, in which the rectangular plane of the upper portion of the driven gear 105 is the mounting plane 1051.

A tilt angle scale (not shown) is provided on an axial end face of the driven gear 105, and the driving gear servo motor 604 of the bottom bracket is manually started, and the tilt angle reaches a target angle, i.e., shutting down; it is also possible to focus on automatic control of the tilt angle, etc. and the automatic control scheme is described in Embodiment 3.

A bottom bracket driving gear servo motor 604 having a rotation axis fixedly connected to the central axis of the driving gear 108 for driving the driving gear 108 to rotate to adjust the tilt angle of the battery support plate 102.

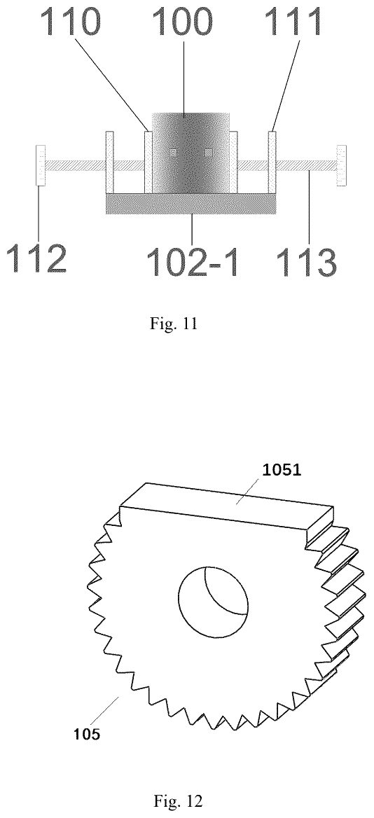

Referring to FIG. 11, in order to prevent the battery from slipping from the battery support plate 102 when the battery support plate 102 is tilted, a battery fixing device is symmetrically provided on the battery support plate 102, including: a clamping plate 110, an side plate 111, a tightening handle 112 and a screw rod 113, where the side plate 111 is fixedly connected to the left and right sides of the first battery support plate 102-1 of the upper plate of the battery support plate 102, a threaded hole is provided on the side plate 111, the screw rod 113 is threadedly connected to the side plate 111 via the threaded hole, the clamping plate 110 is slidably connected to the first battery support plate 102-1, a rotating bearing is provided on the clamping plate 110, one end of the screw rod 113 is rotatably connected to the clamping plate 110 via the rotating bearing, and the tightening handle 112 is fixedly connected to the other end of the screw rod 113; the height of the clamping plate 110 and the side plate 111 are both smaller than the thickness of the battery 100 to prevent the compression head 609 from touching the clamping plate 110 and the side plate 111 when compression the battery.

The expression “securing the battery” according to the present invention means that when the support plate 102 is tilted, the battery 100 placed on the support plate 102 does not slip.

The method for securing the battery includes: the battery 100 is placed between two clamping plates 110 of the first battery support plate 102-1, a tightening handle 112 at two sides is manually screwed, a screw rod 113 pushes the two clamping plates 110 gradually close together, and clamps the battery 100, so that the battery 100 does not slip when the support plate 102 tilts; the process of releasing the battery is the reverse of the fixing process.

### Embodiment 2

The batteries may be at different ambient temperatures in actual use.

Referring to FIG. 9, a liquid temperature regulating system 300 is provided for circulating liquid at various temperatures to the battery support plate 102, which includes an internal duct 302 provided inside a first battery support plate 102-1 of an upper plate of the battery support plate 102;

a liquid circulation duct 303 having one end communicated with the internal duct 302 via a duct connector 301 and the other end communicated with the temperature regulating device 304; and a temperature regulating device 304 is used for maintaining the temperature of the battery, and the specific use can be configured as required, which includes a water pump, a heater and a cooling machine, where after external liquid is heated by the heater or cooled by the cooling machine, the external liquid is circulated by the water pump to a liquid circulation duct 303.

The liquid is anhydrous alcohol or silicone oil or water, the heater and the cooling machine are provided with a temperature regulating switch, and the operator can adjust the temperature of the liquid according to the target temperature, and after the temperature of the battery is consistent with the target temperature, a multi-angle compression test at the target temperature can be performed; it is also feasible to change the temperature of external liquid after the previous test is completed to achieve the compression test at different temperatures.

In order to perform centralized automatic control, a support plate temperature sensor 305 is further provided inside the first battery support plate 102-1 of the upper plate of the battery support plate 102, and a temperature signal of the support plate 102 is collected and processed by a control computer 615, and a control signal is output to control a temperature regulating switch of the heater and the cooling machine, and the automatic control scheme is described in Embodiment 3.

### Embodiment 3

An adjustable tilt angle compression device for mechanical abuse testing of lithium-ion batteries is used for the test method for the mechanical abuse testing, and the method includes the following steps:
step one S1: securing the battery:
securing the battery to the first battery support plate 102-1;
step two S2: adjusting a tilt angle of the battery support plate:
adjusting the tilt angle of the battery support plate 102 to a target angle by a bottom bracket driving gear servo motor 604;
step three S3: adjusting position of the bottom bracket positioning block on the plane:

adjusting the position of the bottom bracket positioning block 109 on the plane via a bottom bracket positioning block transverse movement servo motor 206 and a bottom bracket positioning block longitudinal movement servo motor 207 to adjust a pressed position of the battery;
step four S4: adjusting a vertical position of the compression axis fixing plate 607 and the compression axis limiting plate 401:
adjusting the vertical position of the compression axis limiting plate 401 by driving rotation of a compression axis limiting plate stud 605 via a compression axis limiting plate stud servo motor 610; and
by means of the compression axis fixing plate stud servo motor 611, driving the rotation of the compression axis fixing plate stud 603 to adjust the vertical position of the compression axis fixing plate 607, such that a compression head 609 is about to contact a battery surface while the compression axis limiting plate 401 does not obstruct observation of a thermal runaway flame of the battery;
step five S5: compression test:
controlling the compression axis fixing plate stud servo motor 611 to drive the compression axis fixing plate 607 to press down, so that the compression head 609 performs a compression test on the battery;
step six S6: compressive force value collection:
during the step five S5 test,
collecting vertical force values exerted on the compression axis via the compression axis vertical force value sensor 601;
collecting horizontal force values exerted on the compression axis via the compression axis horizontal force value sensor 405; and
collecting the force values vertical to the battery support plate 102 exerted on the battery via the support plate force value sensor 101.
step seven S7:
S7-1: reselecting a compressed position of the battery:
after the above-mentioned compression test is completed, lifting the compression head 609, and in the case where the battery does not exhibit fire, explosion, or similar hazards, repeating S3, reselecting the pressed position of the battery, and repeating S4-6 to achieve a multi-point test on the battery;
and/or, S7-2, readjusting the tilt angle of the battery support plate:
after the above compression test is completed, lifting the compression head 609, and in the case where the battery is not damaged, repeating S2, adjusting the tilt angle of the battery support plate 102 to a different target angle, and repeating S4-6 to achieve a multi-tilt angle test on the battery.

During the whole process of executing steps S1-7,
the liquid temperature regulating system 300 is started to cyclically deliver liquids at different temperatures to the battery support plate 102 to achieve the compression test at different temperatures:
both the heater and the cooling machine are provided with a temperature regulating switch for controlling the heating or cooling temperature.

When a compression test at a high temperature is required, a heating temperature of a temperature regulating switch is set according to a target temperature, a heater is operated, a liquid is heated, and a water pump circulates the high-temperature liquid to a liquid circulation duct 303;

when the compression test at a low temperature is required, the cooling temperature of the temperature regulating switch is set according to the target temperature, the cooling machine is operated, the liquid is cooled, and the low-temperature liquid is circulated to the liquid circulation duct 303 by the water pump.

The step S2 is performed before the step S3; or, the step S2 and the step S3 are performed simultaneously; or, the step S2 is performed after the step S3.

In the step S5, the following measures are taken to adjust the rotation speed of the compression axis fixing plate stud servo motor 611 to perform compression test on the battery:
by adjusting the rotation speed of the compression axis fixing plate stud servo motor 611, the compression speed is adjusted to achieve the compression at a fixed speed, and specifically, the compression axis fixing plate stud servo motor 611 uses a speed regulating switch to adjust the rotation speed to obtain different fixed speeds, and can also automatically adjust the rotation speed thereof.

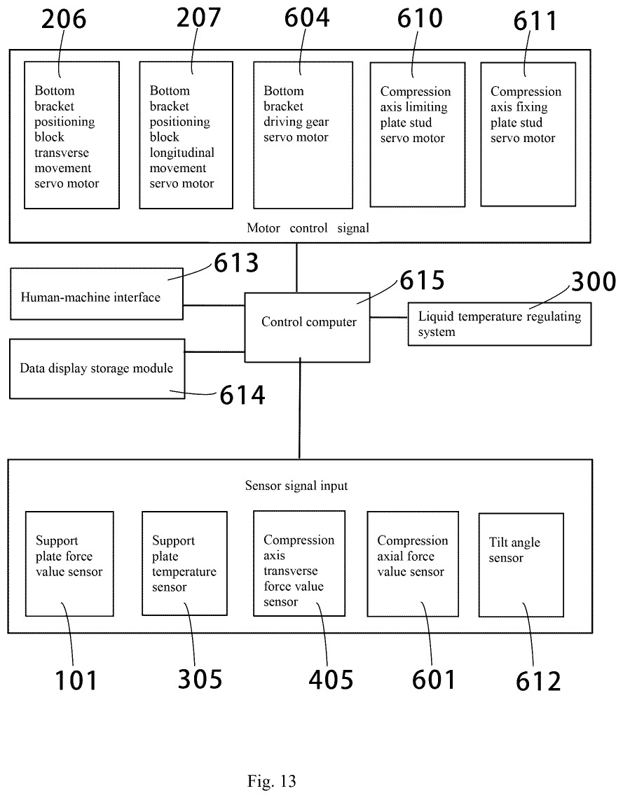

Reference is now made to FIG. 13, FIG. 13 is a block diagram showing an automatic control system that, in order to improve the degree of automation of the present invention, is controlled by a computer. 1. A tilt angle of the battery support plate 102; 2. The rotation speed of the compression axis fixing plate stud servo motor 611; 3. Start-up and shut-down of a heater and a cooling machine as well as temperature regulation; 4. Start-up and shut-down of the bottom bracket positioning block transverse movement servo motor 206; 5. Start-up and shut-down of the bottom bracket positioning block longitudinal movement servo motor 207; 6. Start-up and shut-down of compression axis limiting plate stud servo motor 610.

The automatic control system includes a control computer 615, a human-machine interface 613, a data display and storage module 614, a sensor signal input interface, a motor control signal output interface and a liquid temperature regulating system control signal output interface.

The signal output ends of the support plate force value sensor 101, the support plate temperature sensor 305, the compression axis horizontal force value sensor 405, the compression axis vertical force value sensor 601 and the tilt angle sensor 612 are respectively connected to the corresponding input ends of the sensor signal input interface.

The control signal input ends of the bottom bracket positioning block transverse movement servo motor 206, the bottom bracket positioning block longitudinal movement servo motor 207, the compression axis limiting plate stud servo motor 610, the bottom bracket driving gear servo motor 604 and the compression axis fixing plate stud servo motor 611 are respectively connected to the corresponding output ends of the motor control signal output interface.

The control computer 615 is used for processing the sensor information and displaying the test data through the data display and storage module 614 in real time, and storing the test information at the same time.

When the position of the battery is to be adjusted, after the operator inputs the target position parameter of the battery via the human-machine interface 613, the control computer 615 issues an instruction according to the input position parameter and the existing position, and controls the bottom bracket positioning block transverse movement servo motor 206 and the bottom bracket positioning block longitudinal movement servo motor 207 to start and move a corresponding distance to achieve the objective of adjusting the position of the battery.

When the tilt angle of the battery support plate 102 is to be adjusted, the operator inputs a target tilt angle via the human-machine interface 613; the control computer 615 calculates a difference value with the target tilt angle according to the tilt angle of the existing battery support plate 102 detected by the tilt angle sensor 612, and controls the bottom bracket driving gear servo motor 604 to adjust the tilt angle of the battery support plate 102; and the tilt angle sensor 612 continues to detect the tilt angle of the battery support plate 102, and when the target tilt angle is reached, the bottom bracket driving gear servo motor 604 is shut down.

When the temperature of the battery support plate 102 is to be adjusted, the operator inputs a target temperature through the human-machine interface 613; the control computer 615 calculates the difference value with the target temperature according to the temperature of the existing battery support plate 102 detected by the support plate temperature sensor 305, and controls the heater and cooling machine of the liquid temperature regulating system 300 to adjust the temperature; the support plate temperature sensor 305 continues to detect the temperature of the battery support plate 102; and when the target temperature is reached, the temperature regulation is discontinued to achieve the objective of temperature regulation.

There are three ways to adjust the rotation speed of the compression axis fixing plate stud servo motor 611: in the compression process, the control computer can adjust the rotation speed of the compression axis fixing plate stud servo motor 611 according to the data of the compression axis vertical force value sensor 601 to achieve uniform compression in the vertical direction; the constant speed compression can also be achieved by controlling the compression axis fixing plate stud servo motor 611 at a fixed rotation speed; according to the data of the support plate force value sensor 101, the rotation speed of the compression axis fixing plate stud servo motor 611 can also be adjusted to achieve uniform compression in the vertical direction of the battery.

Meanwhile, the displacements of the support plate force value sensor 101, the compression axis horizontal force value sensor 405, the compression axis vertical force value sensor 601, and the compression head 609 are displayed and stored in the data display storage module 614.

1. An adjustable tilt angle compression device for mechanical abuse testing of lithium-ion batteries, comprising:
a top plate (606);
a group of sensors for collecting compressive force values in the vertical direction, the horizontal direction and the direction vertical to a tilted plane;
a compression mechanism that presses a battery;
a battery support plate (102) for securing the battery;
a planar movement mechanism for moving the battery support plate (102) transversely and/or longitudinally in a plane;
a tilt adjustment mechanism for adjusting tilt of the battery to achieve compression of different tilts of the battery; wherein
the group of sensors includes:
a support plate force value sensor (101) configured to collect force values vertical to the support plate direction exerted on the battery;
a compression axis horizontal force value sensor (405) configured to collect horizontal force values in different directions exerted on the compression axis during battery compression;
a compression axis vertical force value sensor (601) configured to collect vertical force values exerted on the compression axis;
the compression mechanism comprises:
a compression axis fixing plate (607) located below the top plate (606) and is provided with one fixing plate threaded hole, a smooth bore A, a smooth bore B and a smooth bore C;
a compression axis (602) having a top fixedly connected to the compression axis fixing plate (607) via the compression axis vertical force value sensor (601);
a compression axis limiting plate (401) located below the compression axis fixing plate (607) and provided with a threaded hole (402), a first smooth bore (403), a second smooth bore (406) and a third smooth bore (407), wherein a hole is provided in the center, a compression axis limiting linear bearing (404) is provided in the hole, a hole wall of the hole is uniformly distributed and fixedly connected to the plurality of compression axis horizontal force value sensors (405) in the circumferential direction, an outer peripheral wall of the compression axis limiting linear bearing (404) movably abuts against a side wall of the compression axis horizontal force value sensor (405), and the compression axis limiting linear bearing (404) is sleeved on the compression axis (602);
a compression axis fixing plate stud (603) rotatably connected to the top plate (606) and threadedly connected to a fixing plate threaded hole of the compression axis fixing plate (607) and extending into the first smooth bore (403) of the compression axis limiting plate (401);
a compression axis limiting plate stud (605) rotatably connected to the top plate (606), extends through the smooth bore A of the compression axis fixing plate (607), and is threadedly connected to the threaded hole (402) of the compression axis limiting plate (401);
two positioning smooth shafts (608) fixedly connected to a base (201) and the top plate (606), wherein one of the positioning smooth shafts extends through the second smooth hole (406) of the compression axis limiting plate (401) and the smooth bore B of the compression axis fixing plate

(607) and the other extends through the third smooth bore (407) of the compression axis limiting plate (401) and the smooth bore C of the compression axis fixing plate (607);
a compression axis limiting plate stud servo motor (610) mounted below the base (201) for driving rotation of the compression axis limiting plate stud (605), and a rotation speed of the compression axis limiting plate stud servo motor (610) being adjustable; and
a compression axis fixing plate stud servo motor (611) mounted below the base (201) for driving the compression axis fixing plate stud (603) to rotate, and the rotation speed of the compression axis fixing plate stud servo motor (611) being adjustable.

2. The adjustable tilt angle compression device for mechanical abuse testing of lithium-ion batteries according to claim 1, wherein
the battery support plate (102) comprises a first battery support plate (102-1) and a second battery support plate (102-2) which are parallel to each other, and the support plate force value sensor (101) being arranged between the first battery support plate (102-1) and the second battery support plate (102-2);
the planar movement mechanism comprises
a base (201) provided with a bottom bracket positioning block longitudinal movement guide rail (202) and a bottom bracket positioning block transverse movement guide rail (203);
a bottom bracket positioning block transverse movement servo motor (206);
a bottom bracket positioning block longitudinal movement servo motor (207);
a bottom bracket positioning block (109) provided with longitudinal movement threaded holes (104-1) and transverse movement threaded holes (104-2);
a limiting slide block (500) comprising a first limiting slide block (500-1) and a second limiting slide block (500-2) with the same structure, wherein the first limiting slide block (500-1) is slidably connected to a bottom bracket positioning block transverse movement guide rail (203), and the second limiting slide block (500-2) is slidably connected to a bottom bracket positioning block longitudinal movement guide rail (202);
bottom bracket positioning block transverse movement studs (204) threadedly connected to the transverse movement threaded holes (104-2), respectively having one end rotatably connected to the first limiting slide block (500-1) via a stud limiting bearing (503) and the other end fixedly connected to the rotation axis of the bottom bracket positioning block transverse movement servo motor (206);
bottom bracket positioning block longitudinal movement studs (205) threadedly connected to the longitudinal movement threaded holes (104-1), respectively having one end rotatably connected to the second limiting slide block (500-2) via a stud limiting bearing (503) and the other end fixedly connected to the rotation axis of the bottom bracket positioning block longitudinal movement servo motor (207);
the tilt adjustment mechanism comprises:
a bottom bracket (107) fixedly connected to a bottom bracket positioning block (109);
a driving gear (108) fixedly connected to a central axis of the driving gear (108), wherein the central axis of the driving gear (108) is fixedly connected to a driving gear bearing (103), and is rotatably connected to the bottom bracket (107) via the driving gear bearing (103);
a driven gear (105) fixedly connected to a central axis of the driven gear, wherein the central axis of the driven gear is rotatably connected to the bottom bracket (107) via the driven gear bearing (106), and the driven gear (105) and the driving gear (108) are meshed and connected to each other; an outer side face of the driven gear (105) is cut away by a plane parallel to the central axis of the driven gear to form a mounting plane (1051), and the driven gear (105) is fixedly connected to the battery support plate (102) via the mounting plane; and
a bottom bracket driving gear servo motor (604) having a rotation axis fixedly connected to the central axis of the driving gear (108) for driving the driving gear (108) to rotate.

3. The adjustable tilt angle compression device for mechanical abuse testing of lithium-ion batteries according to claim 2, wherein the limiting slide block (500) is provided with a positioning pulley central axis (502) rotatably connected with a positioning pulley (501), and the bottom bracket positioning block longitudinal movement guide rail (202) and the bottom bracket positioning block transverse movement guide rail (203) are provided with a sliding groove matched with the positioning pulley (501) on the outer side.

4. The adjustable tilt angle compression device for mechanical abuse testing of lithium-ion batteries according to claim 3, wherein the number of bottom bracket positioning block transverse movement studs (204) and the transverse movement threaded holes (104-2) matches the number of the bottom bracket positioning block longitudinal movement studs (205) and the longitudinal movement threaded holes (104-1).

5. The adjustable tilt angle compression device for mechanical abuse testing of lithium-ion batteries according to claim 4, further comprising a liquid temperature regulating system (300) for circulating and delivering liquid at different temperatures to the battery support plate (102);
the liquid temperature regulating system comprises:
an internal duct (302) provided inside a first battery support plate (102-1) of an upper plate of the battery support plate (102);
a liquid circulation duct (303) having one end communicated with the internal duct (302) via a duct connector (301) and the other end communicated with the temperature regulating device (304); and
a temperature regulating device (304) comprising a water pump, a heater and a cooling machine, wherein after external liquid is heated by the heater or cooled by the cooling machine, the external liquid is circulated by the water pump to a liquid circulation duct (303).

6. A test method for the adjustable tilt angle compression device for mechanical abuse testing of lithium-ion batteries according to claim 5, wherein the test method for the mechanical abuse testing of lithium-ion batteries comprises the following steps:
(a) securing the battery to the first battery support plate (102-1);
(b) adjusting the tilt angle of the battery support plate (102) to a target angle using a bottom bracket driving gear servo motor (604);
(c) adjusting the position of the bottom bracket positioning block (109) on the plane via a bottom bracket positioning block transverse movement servo motor (206) and a bottom bracket positioning block longitudinal movement servo motor (207), thereby adjusting a pressed position of the battery;
(d) adjusting a vertical position of the compression axis fixing plate (607) and the compression axis limiting plate (401) by:
(i) rotating a compression axis limiting plate stud (605) via a compression axis limiting plate stud servo motor (610); and
(ii) rotating a compression axis fixing plate stud (603) via a compression axis fixing plate stud servo motor (611) to adjust the vertical position of the compression axis fixing plate (607), such that a compression head (609) is about to contact a battery surface while the compression axis limiting plate (401) does not obstruct observation of a thermal runaway flame of the battery;
(e) performing a compression test by controlling the compression axis fixing plate stud servo motor (611) to drive the compression axis fixing plate (607) downward, causing the compression head (609) to compress the battery;
(f) during the compression test, collecting:
(i) vertical force values exerted on the compression axis via the compression axis vertical force value sensor (601);
(ii) horizontal force values exerted on the compression axis via the horizontal force value sensor (405); and
(iii) force values vertical to the support plate via the support plate force value sensor (101);
(g) if the battery is not damaged:
(i) lifting the compression head (609), reselecting a compressed position by repeating step (c), and then repeating steps (d)-(f) for a multi-point test; and/or
(ii) lifting the compression head (609), readjusting the tilt angle by repeating step (b), and then repeating steps (d)-(f) for a multi-angle test.

7. The test method for adjustable tilt angle compression device for mechanical abuse testing of lithium-ion batteries according to claim 6, wherein during the entire testing process, the liquid temperature regulating system (300) is started to cyclically deliver liquids at different temperatures to the battery support plate (102) to achieve the compression test at different temperatures:
when the compression test at a high temperature is required, the heater is operated to heat the liquid, and a water pump circulates the high-temperature liquid to a liquid circulation duct (303);
when it is required to perform the compression test at low temperature, a cooling machine is operated to cool the liquid, and the low temperature liquid is circulated to the liquid circulation duct (303) by the water pump.

8. The test method for adjustable tilt angle compression device for mechanical abuse testing of lithium-ion batteries according to claim 6, wherein adjusting a tilt angle of the battery support plate is performed before, simultaneously with, or after adjusting a position of the bottom bracket positioning block.

9. The test method for adjustable tilt angle compression device for mechanical abuse testing of lithium-ion batteries according to claim 6, wherein during compression, the rotation speed of the compression axis fixing plate stud servo motor is adjusted to perform the compression test on the battery by:
adjusting the rotation speed to achieve compression at a fixed speed;
adjusting the rotation speed based on a force value measured by the compression axis vertical force value sensor to apply a uniform vertical compressive force; or adjusting the rotation speed based on a force value measured by the support plate force value sensor to apply a uniform compressive force perpendicular to the battery surface.
